(19) United States
(12) Patent Application Publication
(10) Pub. No.: US 2005/0085342 A1
(43) Pub. Date: Apr. 21, 2005

(54) Method for controlling a drive device in a vehicle during starting process and corresponding control system

(76) Inventor: Joachim Wiltschka, Meissner Strasse (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/494,933

(22) PCT Filed: Sep. 19, 2002
(86) PCT No.: PCT/EP02/10503

(30) Foreign Application Priority Data
Nov. 9, 2001 (DE) 101-55-216.5

(51) Int. Cl. B60K 41/04

(52) U.S. Cl. 477/110

(57) ABSTRACT

In a method for controlling a drive device in a motorized vehicle during driving off, a driving off process which is to be carried out at a particular time is detected based on sensed operational and driving states of the vehicle. In order to support the driver during the driving off process, the engine setpoint rotational speed is increased automatically and independently of the driver to a value which exceeds the idling setpoint rotational speed of the engine. The engine actual rotational speed is adjusted to the setpoint rotational speed by means of a rotational speed controller by additional injection of fuel.

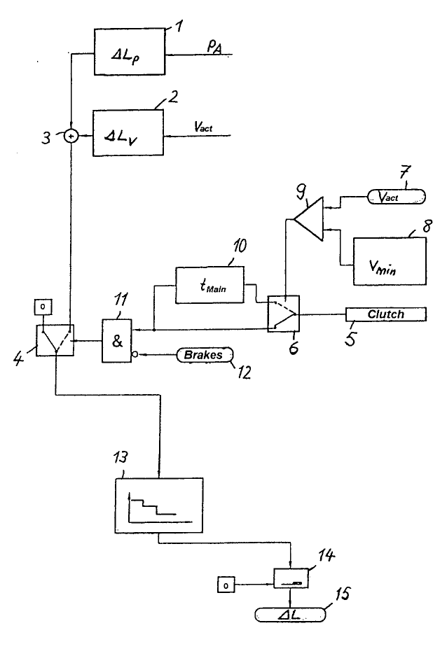

This application claims the priority of German patent document 101 55 216.5, filed 09 Nov. 2001 (PCT International Application No. PCT/EP02/10503, filed 19 Sep. 2002) the disclosure of which is expressly incorporated by reference herein.

### BACKGROUND AND SUMMARY OF THE INVENTION

The invention relates to a method and apparatus for controlling a drive device in a vehicle during driving off processes, in which the vehicle commences movement.

German patent document DE 41 18 332 A1 discloses a system for controlling a drive device of a vehicle, which is configured for driving in low speed stop-and-go situations in which the vehicle repeatedly starts and stops. The driving force of the vehicle is controlled automatically, and the vehicle is automatically accelerated from a stationary state to a target speed, independently of actuation of the accelerator pedal by the driver (provided that the brake pedal is not activated). As soon as the brake pedal is depressed, the automatic acceleration process is aborted and the vehicle is braked again to the stationary state. As soon as the driver stops activating the brake pedal again, the vehicle is accelerated once more to the target speed.

The application of this known control device is restricted to the stop-and-go mode. However, this document does not provide any indication of how to optimize the driving off processes in the normal operational state of the vehicle, in order to reduce the fuel consumption and emissions of pollutants.

German patent document DE 196 16 960 A1 discloses a device for automatically setting a clutch in the drive train of a motor vehicle with an internal combustion engine, during driving off processes and/or gear changing processes. The device comprises an engine rotational speed control circuit which, during driving off and/or gear changing, adjusts the engine rotational speed to a setpoint value which is dependent on the position of the accelerator pedal and/or the speed of the vehicle. In addition, this device also includes a clutch torque control circuit which controls the clutch torque as a function of the difference between a setpoint value, which is dependent on the position of the accelerator pedal, and a return torque actual value, which is derived from the engine torque. This device facilitates comfortable driving off and/or gear changing by setting a clutch torque to a predefined value in addition to the control of the engine rotational speed. As a result changes in torque during the clutch engagement process can be avoided. However, this document does not address the issues of the fuel consumption or the emissions, nor does it provide for optimization thereof.

One object of the present invention is to reduce consumption of fuel and the emissions of pollutants during driving off processes in motorized motor vehicles.

This and other objects and advantages are achieved by the control method according to the invention, in which, it is initially determined, by sensing the operational state and driving state of the vehicle, whether a driving off process is being carried out at a particular time. If so, in order to support the driver during the driving off process, the engine setpoint rotational speed is increased automatically and independently of the driver, to a value which exceeds the idling setpoint rotational speed of the engine. The setpoint rotational speed, which is increased in comparison with the idling rotational speed, is fed as a setpoint value to a rotational speed controller, which in turn adjusts the engine actual rotational speed to the setpoint rotational speed by additional injection of fuel.

This technique provides the advantage that, irrespective of actuation of the accelerator pedal by the driver, the engine rotational speed is increased to an optimum value which, under the given external conditions such as load pressure and atmospheric pressure, permits jolt-free driving off, with minimum fuel consumption and minimum emissions of pollutants. In this manner, the invention provides a saving potential of approximately 2 %, particularly when travelling in the city cycle.

These advantages come into effect in particular in small-volume internal combustion engines which, due to their design, generate only a relatively small engine torque. With such engines, driving off requires a comparatively high rotational speed which must be generated by the driver by activating the accelerator pedal. Without the described driving off aid or the driving off assistant, however, the driver generally predefines an excessively high rotational speed in order to prevent the engine from stalling. The driving off assistant according to the invention avoids unnecessarily high engine rotational speeds during driving off, so that the aforesaid saving potential is obtained.

In one preferred embodiment according to the invention the setpoint rotational speed for the driving off process depends on the speed of the vehicle, and increases as the speed of the vehicle increases. However, it may be expedient to allow the setpoint rotational speed to increase degressively as a function of the speed of the vehicle. This means that the speed of the vehicle also increases without actuation by the driver, with the increase becoming smaller and smaller as the speed increases. As a result, excessively high automatic increases in speed are avoided.

The rotational speed controller automatically converts the increasing engine speed into a corresponding actual rotational speed. Additional hardware components are not required; and it is sufficient to set the rotational speed controller correspondingly at the software level and supply it with the setpoint rotational speed which supports the driver.

The method according to the invention is particularly suitable for use in vehicles with a manual transmission and a clutch, in which it is possible to use the state of the clutch as a triggering criterion for the use of the driving off assistant. The state of a clutch is detected for this purpose, and the setpoint rotational speed is automatically increased if the clutch is in the declutched state and at the same time the brakes of the vehicle are not activated. From the presence of these conditions it is possible to infer a driving off process with sufficient reliability.

The automatic increase in the rotational speed can also be used to compensate driver implemented clutch actuations that deviate from an optimum movement. For example when the clutch is engaged too quickly and the clutch slip is therefore reduced too strongly and the engine rotational speed decreases suddenly, the driving off assistant can compensate by rapidly increasing in the injection quantity, if appropriate up to the limiting value for the injection quantity. On the other hand, if the clutch is opened too wide and the clutch slip is correspondingly very high, the current setpoint rotational speed can be reduced, so that undesired harmonics of the engine rotational speed can be avoided.

In order to avoid a situation in which, immediately after the engine starts with the clutch pedal fully depressed, the driving off assistant is switched on and sets an increased idling rotational speed unnecessarily, triggering of the brake assistant directly after the engine starts can be coupled to the additional condition that the brakes of the vehicle are activated by the driver and subsequently released again or else the driver activates the accelerator pedal. Increased idling rotational speeds after the start are avoided by means of this function.

According to a further expedient embodiment of the invention, the clutch is declutched when the vehicle is already moving, it is possible, to first maintain the engine setpoint rotational speed or reduce it and only subsequently increase it again, for example after a rotational speed-maintaining time has expired or when some other condition applies, for example after the clutch has been engaged again. This deceleration of the clutch signal causes the driving off assistant to be activated with a time delay. As a result, in particular in stop-and-go mode when there is frequent actuation of the clutch pedal, an undesired increase in the setpoint rotational speed is avoided; instead, the engine brake can be used to brake the vehicle. The driving off assistant is not activated again until after the time delay has expired, and the engine rotational speed is increased again.

In the control system according to the invention, which is suitable in particular for carrying out the method, a sensing device is provided for generating actuation signals that represent the operational state and driving state of the vehicle. Furthermore, the engine actual rotational speed is set to a predefined engine setpoint rotational speed by means of a rotational speed controller. A driving off process which is to be carried out at a particular time is detected by means of the sensing device, and an actuation signal is generated for supporting the driver during the driving off process. The actuation signal is fed to the rotational speed controller in which the engine setpoint rotational speed is set automatically and independently of the driver to a value which exceeds the idling setpoint rotational speed. The actual rotational speed is adjusted to this increased setpoint rotational speed.

As an alternative to using the method or the system according to the invention in vehicles with a manual transmission and a driver actuated clutch, it is also possible to use such method or system in vehicles with manual transmission and an automatic clutch, or in vehicles with automatic transmissions.

Other objects, advantages and novel features of the present invention will become apparent from the following detailed description of the invention when considered in conjunction with the accompanying drawings.

### BRIEF DESCRIPTION OF THE DRAWINGS

The FIGURE is a schematic diagram of a control system in a drive device of a vehicle for supporting the driving off processes.

### DETAILED DESCRIPTION OF THE DRAWINGS

Rotational speed increments ΔLₚ and ΔLᵥ (which are added to the normal engine idling setpoint rotational speed) are determined in blocks 1 and 2 of the control system, as a function of the atmospheric pressure p_{A} and the current speed v_{act} of the vehicle, in order to be able to take into account the influence of the atmospheric pressure and of the speed of the vehicle. The dependence on the atmospheric pressure p_{A} is determined in the first block 1, the rotational speed increment ΔLₚ increasing as the atmospheric pressure p_{A} decreases. In the second block 2, the rotational speed increment ΔLᵥ (which is dependent on the speed v_{act} of the vehicle) is determined, and becomes smaller as the speed increases; the increase in the rotational speed depends degressively on the speed of the vehicle.

The rotational speed increments ΔLₚ and ΔLᵥ, are added in block 3 and fed to the block 4 which is embodied as a switch.

The method branch which is illustrated in blocks 5 to 12 represents the switch-on conditions or the actuation of the automatic increase in rotational speed when the vehicle drives off. In a block 5, the state of the clutch is determined and fed to a block 6 which is embodied as a switch and whose switched state is influenced based on a comparison of the actual speed v_{act} from a block 7 with a minimum speed vₘᵢₙ from a block 8, in a block 9 which is embodied as a comparator. If the current vehicle actual speed v_{act} is higher than the minimum speed vₘᵢₙ, which represents a lower threshold value, this means that the vehicle is moving. If so, the switch of the block 6 is moved from the state which is shown by an unbroken line into the state which is shown by dashed lines. A further block 10 performs a time delay with a rotational speed-maintaining time t_{Main}. During the rotational speed-maintaining time t_{Main}, the brake assistant is not activated. The system continues to the further block 11 only after the rotational speed-maintaining time t_{Main} has expired.

If the result of the comparison in the block 9—embodied as a comparator—of the actual speed v_{act} and a minimum speed vₘᵢₙ is that the actual speed is below the minimum speed vₘᵢₙ, the vehicle is considered to be stationary. In this case, no signal is generated in block 9, and the switched state of the switch 6 remains in the state illustrated by the unbroken line according to which the system advances directly to block 11, bypassing the rotational speed-maintaining time t_{Main} of the block 10.

In addition, a brake signal, representing the state of the brakes, is fed to the block 11 from a block 12, and an actuation signal is generated in the block 11 only if both a clutch signal which indicates that the clutch is declutched is supplied from the switch 6 and a signal which indicates that the brakes are not activated is supplied from the block 12. If these two conditions are fulfilled, an actuation signal which is fed to the switch 4 is generated in the block 11, and said switch is moved into a position which is shown by a dashed line in which the sum of the rotational speed increments ΔLₚ and ΔLᵥ is made to pass through the switch 4 and is fed to a further block 13. In the block 13, an overall rotational speed increment ΔL which is composed of the sum of the individual rotational speed increments ΔLₚ and ΔLᵥ is degressively increased according to a predefined decrementation ramp as the speed of the vehicle v_{act} increases, so that the increase in the rotational speed increment becomes smaller and smaller as the speed of the vehicle increases.

Subsequently, in block 14, a lower limitation of the rotational speed increment is performed. In block 15, the ultimate rotational speed increment ΔL is fed to a rotational speed controller in the engine control device and added there to the setpoint idling rotational speed. As a result, the engine setpoint rotational speed which is to be set at a particular time is obtained.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-13. (canceled)

14. A method for controlling operation of a motorized vehicle during driving, off comprising:
sensing an operational state and a driving state of the vehicle;
detecting a driving off process which is to be carried out at a particular time, based on said sensed operational and driving states;
supporting a vehicle driver, during driving off by increasing an engine setpoint rotational speed, automatically and independently of the driver, to a value which exceeds an idling setpoint rotational speed of the engine; and
a rotational speed controller adjusting engine actual rotational speed to the setpoint rotational speed, by additional injection of fuel.

15. The method as claimed in claim 14, wherein:
increasing of the setpoint rotational speed depends on the speed of the vehicle; and
the setpoint rotational speed is increased as the speed of the vehicle increases.

16. The method as claimed in claim 15, wherein the setpoint rotational speed is increased degressively as the speed of the vehicle increases.

17. The method as claimed in claim 1, wherein:
in vehicles with a clutch, the state of the clutch is detected; and
the setpoint rotational speed is increased if the clutch is in the declutched state and the brakes of the vehicle are not activated.

18. The method as claimed in claim 14, wherein in vehicles with a clutch, the setpoint rotational speed is increased automatically immediately after the engine starts, only if the brakes of the vehicle have been activated and released again.

19. The method as claimed in claim 14, wherein in vehicles with a clutch, the setpoint rotational speed is increased automatically immediately after the engine starts, only if the accelerator pedal has been activated.

20. The method as claimed in claim 14, wherein the engine setpoint rotational speed is increased as the atmospheric pressure decreases.

21. The method as claimed in claim 14, further comprising:
detecting that the vehicle is already rolling after declutching has been carried out; and
initially maintaining or decreasing and subsequently increasing the engine setpoint rotational speed.

22. The method as claimed in claim 21, wherein the engine setpoint rotational speed is increased after a speed-maintaining time.

23. The method as claimed in claim 21, wherein the engine setpoint rotational speed is increased when the clutch is engaged again.

24. Apparatus for controlling a drive device in a motorized vehicle during driving off of the vehicle, said apparatus comprising:
a sensing device for generating actuation signals that represent an operational state and a driving state of the vehicle;
a rotational speed controller for setting engine actual rotational speed to a predefined engine setpoint rotational speed;
means for detecting a driving off process which is to be carried out at a particular time, and for feeding an actuation signal to the rotational speed controller in order to support the driver during the driving off process;
wherein said rotational speed controller increases the engine setpoint rotational speed automatically and independently of the driver to a value which exceeds an idling setpoint rotational speed of the engine, and adjusts the engine actual rotational speed to the predefined setpoint rotational speed.

25. The apparatus as claimed in claim 24, in a vehicle with a manual shift transmission and an automatic clutch.

26. The apparatus as claimed in claim 24, in a vehicle with automatic transmission.
